(19) United States
(12) Patent Application Publication
(10) Pub. No.: US 2007/0175983 A1
(43) Pub. Date: Aug. 2, 2007

(54) MULTIFUNCTION INFORMATION CARD DEVICES AND METHODS

(76) Inventor: John R. Klug, Denver, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/625,007

(22) Filed: Jan. 19, 2007

Related U.S. Application Data
(60) Provisional application No. 60/760,693, filed on Jan. 19, 2006.

(51) Int. Cl. G06K 5/00; G06K 19/06

(52) U.S. Cl. 235/380; 235/492

(57) ABSTRACT

An information card device may include a storage device configured to store information as a plurality of sets of information, an input device configured to select one of the plurality of sets of information, and an output device configured to output information of the selected set of information. A method of using an information card device may include: storing information as a plurality of sets of information in a storage device of the information card device; selecting one of the plurality of sets of information; and outputting information of the selected set of information. A system for an information card device may include an information card device including a storage device configured to store information as a plurality of sets of information, and a card device interface configured to interface with the information card device to store information in the storage device.

### CROSS-REFERENCE TO RELATED APPLICATION(S)

This non-provisional application claims the benefit of U.S. Provisional Application No. 60/760,693 filed on Jan. 19, 2006, the entire disclosure of which is incorporated herein by reference.

### FIELD OF THE INVENTION

The inventive field relates generally to information card devices and methods. In particular, the inventive field relates to multifunction information card devices and methods.

### BACKGROUND

Information card devices are generally well known and ubiquitous. A card is used to get out of a parking garage, a credit card is used to buy gas or other purchases, corporate credit cards are used for making certain purchases, “frequent shopper” cards are used to obtain discounts at various restaurants and retailers, ATM cards are used to obtain cash, a card is used to identify yourself at a particular grocery store and obtain preferred prices, and so on. Some cars even require a card device to open the door and start the engine. Further, practically every retailer is constantly offering their own proprietary credit card with attractive discount offers or other incentives.

### SUMMARY

In view of the numerous card devices used throughout daily life, there exists a need to reduce the number of cards an individual needs to carry with them and keep track of.

There also exists a need reduce or even eliminate the costs in time and money associated with updating and replacing the millions of consumer credit cards, such as Visa™, MasterCard™, American Express™, etc.

A need exists to benefit from an information card device that replaces multiple information card devices. For example, a need exists to benefit from an information card device that has the functionality of multiple information card devices.

Embodiments of the invention may provide an information card device that includes sufficient information storage capacity to remedy such needs. Embodiments may further provide an information card device that includes multiple functionalities. Embodiments may further provide an information card device that is rewritable or programmable, for example, based on user input.

In various possible embodiments, a user may store information related to a plurality of different information card devices on a single card device and select one of the plurality of different information card devices for use as desired. For example, the single card device may function as the selected one of the plurality of different information card devices.

In an example embodiment, an information card device may include an input device, such as a keyboard or a touch screen, that allows a user to input data. Such an input device may allow a user to input data related to specific information stored on the information card device, to input data to select specific information stored on the information card device for use, and/or to store information on the information card device.

In an example embodiment, an information card device may include an information output device, such as a magnetic stripe or a transmitter, that allows the information card device to share information stored on the information card device, for example, to complete a transaction. Such an output device may be configure to only share information stored on the information card device that is selected by a user of the information card device.

Embodiments of the invention may also make it possible to improve security of information card devices. For example, an information card device may include a security device, such as a fingerprint reader or a retinal scanner, that prevents unauthorized access to and/or use of information stored on the information card device. Such a security device may, for example, be used for verification/authorization before certain types of information are accessed/used and/or before certain types of transactions are possible using the information card device.

In an example embodiment, an information card device may include a power supply, such as a battery and/or a photosensitive voltaic cell, that provides power to various components of the information card device. For example, such a power supply may be used to power a storage device, a processor, a display device, an input device, an output device and/or a security device of the information card device. Such a power supply may advantageously be configured to receive power from an information card reader or other interface designed to interact with the information card device, for example, so as to recharge the power supply during normal use of the information card device.

In an example embodiment, an information card device may be configured to be programmed with information and functionality by a separate computer, for example, via the internet. For example, the information and functionality of a particular credit card may be stored on the information card device by downloading from an internet site operated by the particular credit card company.

Where appropriate or desired, embodiments of the information card device may be “smart.” For example, the information card device may be configured to sense the nature of a transaction or intended use. For example, if the user is attempting to use the information card device to purchase gasoline, the information card device may sense that the purchase is being made at a particular gas station and may select information stored on the information card device that is associated with the particular gas station, e.g., the user's gas station credit card information, to be used for the transaction. Alternatively or additionally, the information card device may suggest the information to be used to the user prior to selection.

Embodiments of the invention may provide an information card device with various other features and capabilities as described further herein.

Embodiments of the invention may also provide systems and methods for using and/or programming an information card device with such enhanced capabilities.

### BRIEF DESCRIPTION OF THE DRAWINGS

Various details of the present invention may will be better understood on reading the following detailed description of non-limiting embodiments, and on examining the accompanying drawings, in which:

FIG. 1 shows an exemplary information card device;

FIG. 2 is a block diagram of another exemplary information card device; and

FIG. 3 is a block diagram of an exemplary information card device system.

### DETAILED DESCRIPTION

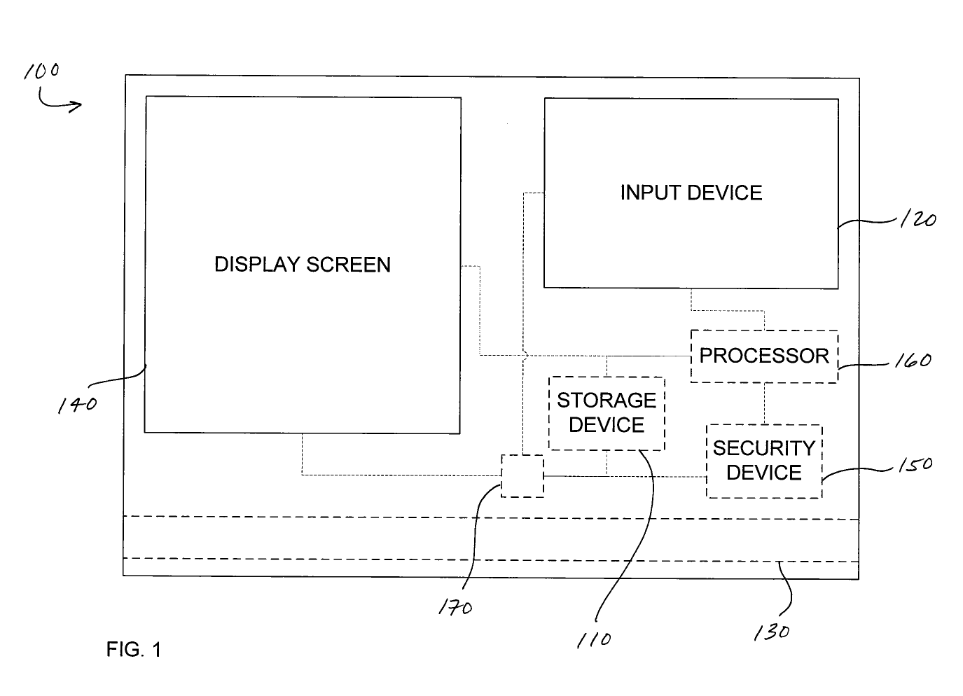

One example of an information card device 100, as shown in FIG. 1, may comprise a storage device 110 that is configured to store information as a plurality of sets of information. For example, the storage device 110 may be configured to store sets of information associated with particular credit cards and/or accounts, etc., which may allow the information card device 100 to replace or otherwise function as one of a plurality of credit and/or debit cards as described herein. The storage device 110 may be any known or hereafter developed storage device suitable for storing data.

The information card device 100 may also include an input device 120 that allows a user to select one of the plurality of sets of information stored by the storage device 110. The input device 120 may also allow the user to store various information in the storage device 110 and/or to manage information in the storage device 110. The input device 120 may be a keyboard, or may be a touch screen or any other known or hereafter developed input device.

The information card device 100 may also include an output device 130 that is configured to output information based on a selection made by the user using the input device 120. The output device 130 may be a magnetic stripe, such as commonly used for credit cards, or may be a transmitter or any other known or hereafter developed output device suitable for electronic transfer of data.

The information card device 100 may also include a display device or screen 140. The display device 140 may be configured to display information input by the input device 120, information of the selected set of information, and/or information output by the output device 130, for example. The display device 140 may be any known or hereafter developed display device suitable for displaying information for visual perception by a user.

The information card device 100 may also include a security device 150. The security device 150 may be configured to prevent unauthorized access to and/or use of information stored on the information card device. The security device 150 may be a fingerprint reader, for example, or may be a retinal scanner or any other known or hereafter developed security device that is suitable for restricting access to and/or use of stored information. The security device 150 may, for example, be used for verification/authorization before certain types of information are accessed/used and/or before certain types of transactions are possible using the information card device 100.

The information card device 100 may also include a processor 160. The processor 160 may be configured to implement the desired functionality of the storage device 110, the input device 120, the output device 130, the display device 140 and the security device 150. As such, it will be understood that the processor 160 may be any suitable processing device, circuit, etc., whether known or hereafter developed, that is suitable for controlling such devices. The processor and other devices, as shown in FIG. 1, are in operable communication, whether through traces on a printed circuit board, wires, or otherwise.

The information card device 100 also includes a power source 170, such as a battery. The power source 170 may supply power to each of the storage device 110, the input device 120, the output device 130, the display device 140, the security device 150 and the processor 160, as appropriate or desired. The power source 170 may be rechargeable, for example, and may alternatively or additionally comprise a photosensitive voltaic cell to allow the power source 170 to charge from ambient light sources.

It should be understood that the functionality of the various components of the information card device 100 may be combined, and thus various components may be omitted. For example, the display device 140 may function as the output device 130 by displaying a bar code containing the information to be output. Also, the display device 140 may also be the input device 120, for example.

The storage device 110, the security device 150, the processor 160 and the power source 170 are illustrated in FIG. 1 in dashed lines to indicate that these components may be embedded within a body of the information card device 100 or may be disposed on an opposite side of the information card device 100, as appropriate or desired. However, it should be understood that the location and arrangement of the various components is not limited to that illustrated. It should also be understood that, although links between the various components are illustrated by lines in the Figures, any links may be wired or wireless, as appropriate or desired.

In use, a user may store, for example, information from a plurality of credit cards as corresponding sets of information in the storage device 110. The information card device 100 may then be carried with the user for making purchases as needed, without having to carry each of the plurality of credit cards. When the user wants to make a purchase, the user may use the input device 120 to select one of the sets of information corresponding to the desired credit card, for example, by inputting the name of the desired credit card, such as Visa™. The processor 160 then accesses the selected set of information from the storage device 110, and makes the selected set of information available for output via the output device 130. For example, in the case of a magnetic stripe as the output device 130, the information card device 100 may be swiped as conventionally done for a credit card to make the desired purchase.

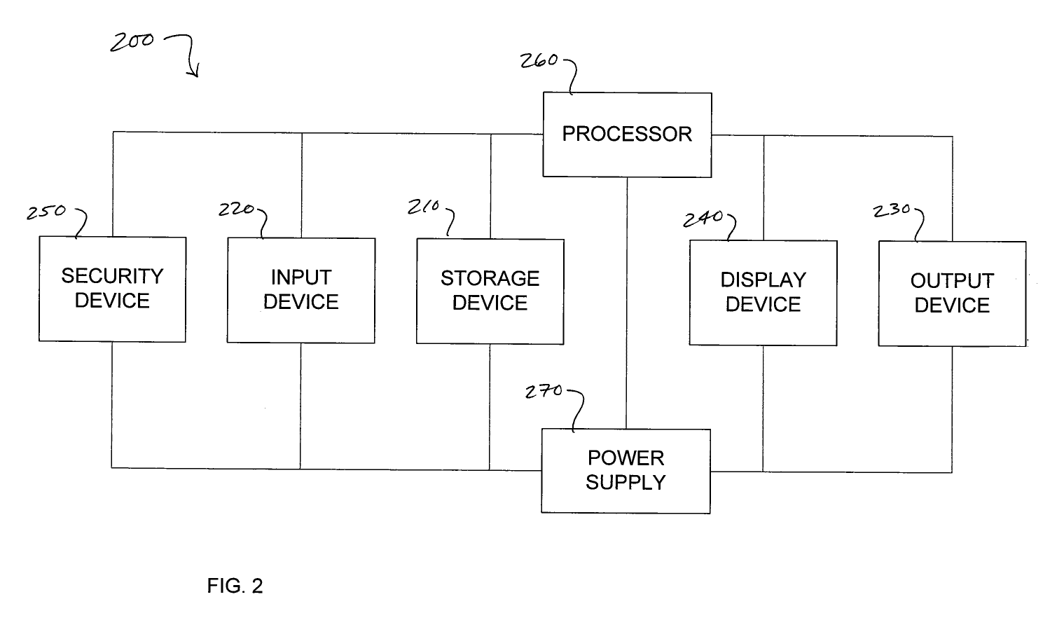

Another example of an information card device 200 is shown in FIG. 2. The block diagram of FIG. 2 illustrates that the information card device 200 may be a card or another type of device. For example, the information card device 200 may be an RFID (radio frequency identification) device or any other known or hereafter developed electronic device.

The information card device 200 may include a storage device 210, an input device 220, an output device 230, a display device 240, a security device 250, a processor 260 and/or a power source 270. Each of these components may be as described above with respect to the corresponding components of FIG. 1. Thus, the information card device 200 may provide the same features and functionality, as described throughout this disclosure.

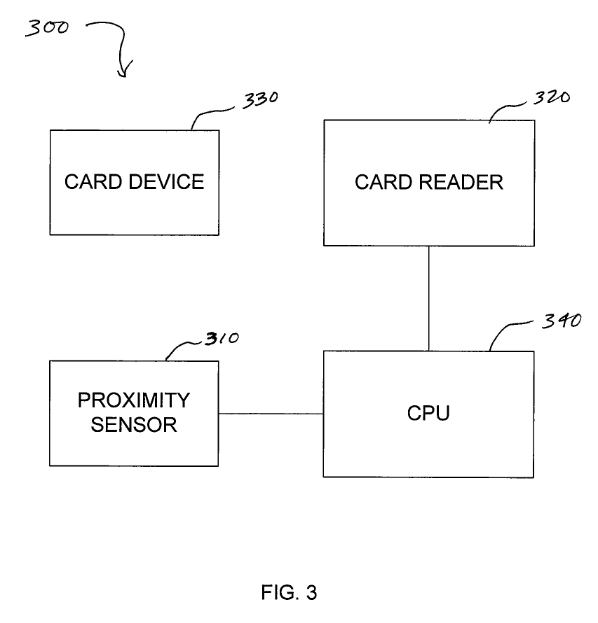

FIG. 3 illustrates an exemplary system 300 for an information card device, such as described above with respect to FIGS. 1 and 2. The system may include an interface, such as a proximity sensor 310 and/or a card reader 320, that allows an information card device 330 to exchange information with a computer device or CPU 340. The proximity sensor 310 may be configured to sense the presence of the information card device 330 to activate the card reader 320, the CPU 340, or both. The card reader 320 may thus share information with the information card device 330 remotely, for example, by wireless communication.

Alternatively, the proximity sensor 310 may be omitted, for example, by having the card reader 320 incorporate such a sensing function and/or having the card reader 320 physically interface with the information card device 330, for example, by swiping or docking the information card device 330. Such a physical interface may facilitate more secure information sharing, for example, and may enable sharing information in a manner that is less suitable for wireless transmission, such as magnetically.

The system 300 may allow information to be stored in the information card device 330 from the CPU 340. For example, the CPU may access information associated with a particular credit card, for example, by accessing the particular credit card provider's web site via the internet. The accessed information may be provided from the CPU 340 to the card reader 320 and stored in the information card device 330 by the card reader 320. The information card device 330 may then be used as the particular credit card, for example, as described above.

The system 300 may also allow information to be provided to the CPU 340 from the information card device 330. For example, the card reader 320 may access information from the information card device 330 that allows the CPU 340 to access information associated with the particular credit card, for example, by obtaining a password or other confidential account information from the information card device 330. Further, the card reader 320 may access information from the information card device 330 regarding transactions and/or account status, for example, to allow a user to view and or manage such information using the CPU 340. The system 300 may also allow a complete backup on the CPU 340 of the information stored in the information card device 330.

Such a backup may include any existing cash balances on the information card device and the like, for example, to help prevent lost funds in case of loss of the information card device. Further, a replacement information card device may easily be programmed with the information stored on the lost information card device using such a backup. Security verification requirements, as discussed herein, would prevent use of or access to the information stored on the lost information card device. Unauthorized use or access may provide a notification to allow the user to prevent completion of an attempted transaction or at least prevent further transactions. Such a functionality may be provided by an electronic network, such as one associated with the information card device.

Numerous methods for an information card device, including uses of the information card device and associated systems, including storing, retrieving and/or managing information using the information card device and/or associated systems, will be understood from the foregoing exemplary embodiments and the entirety of this disclosure. The characteristics of the various embodiments as well as the additional features described herein may be combined with one another, as appropriate or desired.

The information card device may be a credit card-sized device, but is not restricted to such size. Such sized devices, however, are currently capable of providing gigabytes of data storage, which is very useful for the information card device.

The input device may allow alphanumeric data entry, for example, but any suitable type of data entry is contemplated. For example, as discussed above, a touch screen input may allow input by selecting icons or buttons, or by drawing shapes, such as with a stylus. The input device may be pressure or heat sensitive, or may be sensitive to a specific user input instrument.

Security verification for use of the information card device and/or access to information stored in the information card device may be required for certain types of transactions, such as purchases exceeding a particular dollar amount, and/or certain types of information, such as sensitive or confidential information, including, but not limited to, passwords, access codes, credit card numbers and personal information that may be used to establish a person's identity. Such security verification may be varied based on the desired use or access. For example, security verification may be random, periodic, or triggered by an event, such as use or access that is inconsistent with the user's history, for example, similar to approaches used to prevent credit card fraud and unauthorized use.

The interface for the information card device, such as the card reader described above, may function as a charger for the power source of the information card device. Thus, the power source of the information card device may be automatically recharged during normal use.

Security verification needed to access information from a web site as discussed above may be separately input to the computing device/CPU by the user rather than obtained from the information card device. Such sharing of information may thus allow secure storage of information in the information card device, including updating of information already stored in the information card device, and secure downloading of information from the information card device. Multiple credit cards may be programmed into the information card device in this manner or by any other known or hereafter developed manner of transferring information.

As an example, a user may wish to purchase gasoline and have the purchase charged to his Visa™ account. After any required security verification, the user may use the input device of the information card device to select the Visa™ account information stored in the information card device. For example, by typing with a finger, stylus, pencil or pen tip, etc. on the keyboard or drawing on the touch screen, the word “VISA”, the letter “V” or any other name for the Visa™ account, or by selecting a corresponding icon or button, the Visa™ account information may be made available. Once available, normal purchase transaction procedures may be used as if the information card device is a conventional Visa™, for example, swiping, contacting or placing the information card device in proximity with a POS (point of sale) device. The information card device may thus provide information, such as name, credit card number, security code(s), etc., that may be needed to complete the transaction.

The information card device may remain active as the Visa™, in the Visa™ mode, until the user alters the status of the information card device, for example, to allow multiple transactions without further user input. Alternatively, a selection by the user may be required for each individual transaction contemplated. Further, security verification could be required for use of the information card device after each transaction is completed.

Multiple Visa™ accounts are possible. Thus, each type of Visa™, such as airline miles, hotel points, cash back, etc., may be suitably named or otherwise identified. In particular, such identification may allow the information card device to suggest an appropriate selection to the user, for example, based on a property of the transaction contemplated, a special incentive, a user's preferences, or other relevant information.

Further, for frequent travelers or for business travel, a particular credit card may be specified for a given trip so that the information card device selects the appropriate card information. Additionally, the information card device may facilitate travel and entertainment expense recordkeeping by associating trip designations with particular credit cards and/or transactions. For example, all expenses associated with a trip “A” may be associated with “Corporate Visa—trip A” and all expenses associated with a trip “B” may be associated with “Corporate Visa—trip B.” The information card device may thus provide such detailed and organized information to the traveler and/or the corporation.

The information card device may also store a record of each transaction. For example, this may eliminate any need for a receipt for a purchase, and the potential for loss of the receipt. Further, memory of purchases may be rendered unnecessary for proper review and reconciliation of a monthly credit card statement. This may also simplify any potential billing disputes with the credit card company, thus saving time and money. All information regarding purchases, such as merchant, amount, date, card, etc., may be tracked and stored by the information card device and uploaded to a computing device/CPU, for example, using a card reader as discussed above. Such uploading may facilitate electronic reconciliation and electronic payment by computer, with suitable software designed for such functions.

The information card device may also be used as a debit card to charge directly against funds deposited with a financial institution, such as a bank. The information card device may further include features for easier financial planning, avoiding exceeding credit limits and avoiding overdrafts.

For example, the information card device may be loaded with a certain amount of money, such as via the internet through a financial institution. This would allow immediate payment for debit card and/or credit card purchases from the balance of the amount of money loaded on the information card device. As such, a user of the information card device may decide which card information to use for a given purchase and whether to debit to the funds balance on the information card device or proceed to credit/debit processing of the particular card.

To avoid overdrafts, the information card device may be configured to display the remaining balance and/or to automatically warn the user, either with an audible alarm and/or a flashing display, as the balance drops to within a certain amount of being depleted, thus alerting the user to load additional funds onto the information card device. Similarly, to avoid exceeding credit limits, remaining credit available may be displayed and the user may be warned/notified, as discussed above. Further, funds loaded onto the information card device may be identified for a particular use, such as “Corporate Visa—trip A.”

The information card device may also be used to store, display and remind the user of due dates for payments, minimum amounts due, interest rates charged on unpaid balances, etc. for each card stored in the information card device. The information card device may further provide spreadsheet analysis, for example, using artificial intelligence software, to make suggestions regarding managing accounts and balances. Such analysis may be built into the information card device or an associated website, for example to help the use facilitate maximum credit flexibility and/or minimum cost in fees and interest. Further, the information card device may also be compatible with available personal financial management software, such as Quicken™.

The information card device may also include real-time currency converters, for example, for purchases in foreign countries. The information card device may also be capable of use in ATMs in foreign countries to obtain foreign currencies.

Other related or unrelated data may also be stored in the information card device. For example, the user may use a personal Registrar site, such as described in U.S. Pat. No. 5,790,785, which is incorporated herein by reference in its entirety, to download various demographic, psychographic, shipping or billing information, avatar identities and other data useful for purchases or other transactions, electronic games, etc.

As an example, a user at the checkout of a retailer may request that an item be shipped to them and allow the information card device to be used for both payment and shipping information. Or the user could insert the information card device into a card reader before signing onto the EverQuest™ multi-player internet website and have the logon, payment, avatar selection, play level, etc. automatically transmitted to the EverQuest™ website.

The information card device may be programmable to be the only device needed to facilitate hundreds of encounters a user may have in daily life for data of any type. For example, the information card device may be programmed to allow one-key directions to the user's home, which may be translated by the information card device as needed, for example, to obtain a cab ride home from a non-English speaking cab driver, or to interface with a navigation system of a vehicle, while possibly being used to unlock and start the vehicle.

The information card device may be integrated with other devices and/or functionalities, such as, cell phones which may operate as computers, calculators, e-mail devices, internet devices, payment devices, MP3 players, video player, and the like. Further, the information card device may be into other electronic devices including PDAs, digital cameras, and other portable devices, such as an iPod. Thus, the information card device may further reduce the number of devices a person need carry or even purchase. It should be understood that the description provided herein relates to devices, systems and methods that may be incorporated into other devices.

The information card device may include an RFID device and transmitter that may be triggered, for example, by a phone call to a certain number or a signal entered by a handheld device, etc. Thus, if the information card device is misplaced, it may be caused to “chirp” or send GPS coordinates to assist recovery.

The display device of the information card device may be an LCD type like the relatively high resolution screen that is currently contained in the Palm Treo 650™ type cell phone/PDA. Also, a touch sensitive keyboard as an input device may be beside, above or below the screen. This may be on one side of the information card device, although another screen may be on the other side along with a magnetic stripe. When not being used, the screen may possibly be used as the light sensitive photo-voltaic source energy for battery recharge. Of course, the screen and keyboard may be sized such that they fit the credit-card size of the information card device. The screen and keyboard of the Treo 650™ are about the total size of a credit card. The screen of the information card device may be capable of displaying photos, alpha-numeric characters, and other bit mapped images, etc., similar to the Treo type screen.

The move to “proximity” readers as compared to physically having to “swipe” or “insert” a currently-sized credit card allows the information card device to be a size other than the current credit card size.

The screen may display, for example, bar codes that may be swiped at retail checkout locations. Thus, the information card device may include the exact functionality of existing cards that include barcodes, such as the frequent shopper type cards used at restaurants, grocery chains, and the key chain plastic pieces.

A high resolution screen in combination with high security of the information card device, such as fingerprint or retinal scan capabilities, voice recognition, and other high tech security techniques, may allow the information card device to replace other documents typically carried, such as a drivers license, security or identity passes and cards, or even a passport.

The information card device may also literally become a substitute for money with direct debit to the currency balances on the card, as discussed above, rather than debiting back through a traditional credit/debit card network. Currency may also be defined on the information card device as any fungible proxy of value such as PayPal™ credits, etc. And, of course, as referenced above, currencies may be interchangeably denominated in any currency in the world with cross-rates downloaded daily or in real time to the information card device, for example, through wireless networks with which the information card device is compatible.

The term “card reader” should be understood broadly as a device, method and/or system that allows information to be transferred. For example, Bluetooth™ capability and other wireless connections may allow the information card device to remain physically disconnected from a computer and/or the internet while maintaining its functions.

The information card device may not be a card at all and may be, for example, a “nano” type device or system. For example, RFID devices and computer chips may be smaller than a grain of rice and may even be permanently implanted in humans and animals. Such RFID chips may be programmed to hold vital personal identity data, medical history, even birth certificates. The advantage of this is that the user may never lose their vital personal data, as well as such medical data as allergies, drug reactions, blood type. etc.

All the data and functionality of the information card device may similarly be incorporated into an RFID chip. Rather than carry an information card device, such functionality may literally be implanted into the user. Of course, some sort of external “reader” and “programming device” would be necessary to transfer data to and from the RFID type information card device. Such devices already exist and may be reconfigured so as to be small and conveniently available to the user on his/her person. Such same device, or other devices and systems and methods may be used to facilitate computer and internet usage, etc. in association with information card device functionality. For example, the data reading and transfer capability and computer and internet functionality may be programmed into another ubiquitous device, such as the user's cell phone or iPod.

The systems, methods and devices described herein may involve various possible combinations of a data storage device (e.g., the miniature RFID implanted chip), the data processing device (e.g., the RFID chip, and/or another processor such as might be contained in a reader and programming device, or within, for example, a cell phone), the power source, the power storage, the recharge source, the software, the display capability, the wireless transmission capability (e.g., Bluetooth™), the method to access the internet and all other components or capabilities to accomplish information card device functionality as described herein.

Storing one's medical history electronically with the capabilities of the information card device and in association with other information card device capabilities is contemplated in particular. For example, certain key data such as one's blood type or life threatening allergies, or Parkinson's Disease which might cause erratic movement and any other vital medical data may be made “public,” meaning that it is available to anyone at any time, for example, merely by typing in the appropriate keyword(s) into the information card device. That way, in an emergency, EMT's and doctors may immediately know the patient's vital medical information without gaining permission from the patient who may be unconscious. Virtually instant access to this data may be lifesaving, as will be appreciated.

Of course, confidential medical data may also be stored on the information card device so as to be available only with the permission of the information card device owner, or only to medical personnel who have a “need to know.” This medical information including changes and updates may be input by the information card device owner or may be downloaded at the time that medical care is provided either by radio frequency transmission by the provider, direct “swiping” of the card by the provider, transmission by internet or other file transfer containing the data which the information card device owner may upload to the information card device, or other suitable modes of input, transmission and update. The medical data may be segregated using the information card device by the owner, or medical personnel, into type of medical condition (Urology, Cardiac etc.), test results, dates, and any other single criterion or multiple sort criteria of interest to the information card device owner or medical personnel. Literally one's entire medical life history may be stored on the card, manipulated, updated, and downloaded as needed and as appropriate. Appropriate passwords, bio-metric controls, fingerprint(s) and/or other security measures may be employed to protect the data, as previously discussed.

Although various details of the present invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

It is claimed:

1. An information card device, comprising:
a storage device configured to store information as a plurality of sets of information;
an input device configured to select one of the plurality of sets of information stored by the storage device; and
an output device configured to output information of the selected set of information.

2. The information card device of claim 1, further comprising a display device configured to display at least one of information input by the input device, information of the selected set of information, and information output by the output device.

3. A method of using an information card device, comprising:
storing information as a plurality of sets of information in a storage device of the information card device;
selecting one of the plurality of sets of information stored in the storage device; and
outputting information of the selected set of information.

4. The method of claim 3, further comprising displaying at least one of information input by the input device, information of the selected set of information, and information output by the output device on a display device of the information card device.

5. A system for an information card device, comprising:
an information card device including a storage device configured to store information as a plurality of sets of information; and
a card device interface configured to interface with the information card device to store information in the storage device of the information card device.

6. The system of claim 5, further comprising a computer configured to access information from the internet and configured to provide information to the card device interface.
